(19) United States
(12) Patent Application Publication
(10) Pub. No.: US 2006/0133955 A1
(43) Pub. Date: Jun. 22, 2006

(54) Apparatus and method for delivering vapor phase reagent to a deposition chamber

(76) Inventor: David Walter Peters, Tonawanda, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/013,434

(22) Filed: Dec. 17, 2004

(51) Int. Cl. B01L 3/00

(52) U.S. Cl. 422/63; 422/100

(57) ABSTRACT

This invention relates to a vapor phase reagent dispensing apparatus or assembly having a liquid reagent level sensor for sensing liquid reagent level in the apparatus interior volume and a temperature sensor for sensing temperature of the liquid reagent in the apparatus interior volume. The floor of the apparatus has a cavity therein extending downwardly from the surface of the floor, and the lower ends of the liquid reagent level sensor and temperature sensor are positioned in the cavity. The dispensing apparatus may be used for dispensing of reagents such as precursors for deposition of materials in the manufacture of semiconductor materials and devices, and achieves a high level of withdrawal of the liquid reagent from the vessel.

### FIELD OF THE INVENTION

This invention relates to a vapor phase reagent dispensing apparatus that may be used for dispensing vapor phase reagents such as precursors for deposition of materials in the manufacture of semiconductor materials and devices. The dispensing apparatus has a liquid reagent level sensor for sensing liquid reagent level in the apparatus interior volume and a temperature sensor for sensing temperature of the liquid reagent in the apparatus interior volume. The floor of the apparatus has a cavity therein extending downwardly from the surface of the floor, and the lower end of the liquid reagent level sensor and temperature sensor are positioned in the cavity.

### BACKGROUND OF THE INVENTION

Modern chemical vapor deposition and atomic layer deposition tools utilize bubblers or ampoules to deliver precursor chemical to the deposition chamber. These ampoules work by passing a carrier gas through a container of liquid precursor chemical and carrying the precursor vapor along with the gas. In most cases, it is necessary to heat the ampoule by some means in order to increase the vapor pressure of the precursor and thus increase the amount of chemical in the carrier gas. It is important to monitor the temperature of the liquid precursor chemical inside of the ampoule to control the vapor pressure.

It is important to know when the liquid precursor chemical inside of the ampoule is close to running out so that it can be changed at the end of a chemical vapor deposition or atomic layer deposition cycle. If the ampoule should run dry in the middle of a cycle, the entire batch of wafers will be ruined resulting in a potential loss of millions of dollars. It is therefore desirable to leave as little liquid precursor chemical as possible inside of the ampoule to avoid wasting the valuable liquid precursor chemical. As the cost of chemical precursors increase, wasting as little chemical as possible becomes more important.

Most liquid level sensors have a dead space of several tenths of an inch or more which leaves too much chemical (up to 15% or more) in the ampoule when the sensor triggers. A need exists to improve the design of the ampoule to minimize the amount of liquid precursor chemical remaining when the level sensor triggers. Because semiconductor manufacturing processes typically operate in a batch process fashion, with respect to the deposition of constituent materials on the wafer substrate from the vaporized source material, the non-used reagent from the supply vessel becomes part of the overall waste from the semiconductor manufacturing plant.

In instances where the liquid precursor chemical is costly and valuable, such waste of the liquid precursor chemical adversely impacts the process economics, as well as representing a significant burden in terms of disposition of the waste liquid and its environmental impact.

U.S. Pat. No. 6,077,356 discloses a closed vessel liquid reagent dispensing assembly of the type in which liquid is dispensed from a dip-tube discharge conduit from a gas pressurized vessel, and in which the liquid level may be sensed by a sensor extending downwardly in the vessel and terminating just short of the floor thereof. The floor of the vessel has a sump cavity in which the lower ends of the dip-tube liquid discharge conduit and liquid level sensor are disposed. The liquid reagent from the vessel is passed to a vaporizer and vaporized to form a source vapor which is flowed to a chemical vapor deposition chamber.

It would be desirable in the art to provide a vapor phase reagent dispensing apparatus and method which increases the usage of the liquid precursor chemical in the apparatus, and correspondingly reduces waste thereof, and eliminates the need for added steps and hardware, e.g., vaporization step and vaporizer, required by liquid reagent dispensing vessels of the prior art in flow communication with a chemical vapor deposition chamber.

### SUMMARY OF THE INVENTION

This invention relates to a vapor phase reagent dispensing apparatus or assembly comprising:

a vessel bounded on its upper end by a top wall member and on its lower end by a bottom wall member to define therewithin an interior volume;

the bottom wall member having a main floor surface containing a sump cavity therein extending downwardly from the main floor surface, the sump cavity being bounded at its lower end by a sub-floor surface, with at least a portion of the sump cavity being centrally located on the bottom wall member and at least a portion of the sump cavity being non-centrally located on the bottom wall member;

a temperature sensor extending from an upper end exterior of the vessel through a centrally located portion of the top wall member and generally vertically downwardly into the interior volume of the vessel to a lower end of that portion of the sump cavity centrally located on the bottom wall member, with the lower end of the temperature sensor being located in non-interfering proximity to the sub-floor surface of the sump cavity;

a liquid reagent level sensor extending from an upper end exterior of the vessel through a non-centrally located portion of the top wall member and generally vertically downwardly into the interior volume of the vessel to a lower end of that portion of the sump cavity non-centrally located on the bottom wall member, with the lower end of the liquid reagent level sensor being located in non-interfering proximity to the sub-floor surface of the sump cavity; and

the temperature sensor being operatively arranged in the sump cavity to determine the temperature of liquid reagent in the vessel, the liquid reagent level sensor being operatively arranged in the sump cavity to determine the level of liquid reagent in the vessel, the temperature sensor and liquid reagent level sensor being located in non-interfering proximity to each other in the sump cavity, with the lower end of the temperature sensor being located at the same or closer proximity to the sub-floor surface of the sump cavity in relation to the lower end of the liquid reagent level sensor, and the temperature sensor and liquid reagent level sensor being in liquid reagent flow communication in the sump cavity.

The internal configuration of the ampoule or vessel has a small well or sump cavity that the liquid reagent level sensor and temperature sensor project down into. The cross sectional area of this sump cavity is substantially less than that of the main body of the vessel or ampoule which means the remaining volume when the liquid reagent level sensor trips is substantially less than what would be remaining in the main body of the ampoule. This effectively eliminates the dead space inherent in other level sensors such as ultrasonic or optical level sensors.

In contrast to the liquid reagent dispensing assemblies of the prior art, the vapor phase reagent dispensing apparatus of this invention does not require a dip-tube liquid discharge conduit for discharging liquid from the vessel. In addition, the prior art discloses a well in the context of delivering a liquid whereas this invention is designed to deliver a vapor phase reagent. Also, this invention couples the liquid reagent level sensor and temperature sensor together in one sump cavity thus making the operation of the vessel inherently safer.

As indicated above, the sump cavity has been extended to include the temperature sensor, e.g., thermowell and thermocouple, so that the liquid reagent level sensor and temperature sensor are both at the same level. In this way, the temperature sensor is wet as long as the liquid reagent level sensor is wet. This is an important safety consideration. If the temperature sensor was dry while the liquid reagent level sensor indicated the presence of chemical, it could lead to heating of the ampoule to unsafe temperatures. The ampoule design of this invention ensures that the temperature sensor is still wet even after the level sensor indicates that the ampoule should be changed.

The ampoule, typically a stainless steel container, delivers 90% to 99% of a chemical that is a solid or liquid at room temperature. It is heated to deliver chemical in vapor form, and comprises a sump cavity in its floor, means for filling the container, means for introducing a gas to mix with the chemical vapor in the headspace above the gas-liquid interface, means for withdrawing the resulting mixture of gas and vapor, means for temperature and liquid reagent level measurements, and means for isolating it from its surroundings. The vessel or ampoule is characterized by the sump cavity whose cross sectional area is significantly smaller than the main body, it co-locates a temperature sensor and a liquid reagent level sensor, is dimensioned such that these are always submerged in liquid or liquefied chemical, and the temperature sensor and liquid reagent level sensor are positioned away from the walls of the container and more towards its center. The temperature sensor is centrally positioned in the vessel and the liquid reagent level sensor is non-centrally positioned within the vessel.

This invention also relates to a vapor phase reagent dispensing apparatus or assembly described above further comprising:

a non-centrally located portion of the top wall member having a carrier gas feed inlet opening;

a carrier gas feed line extending from the carrier gas feed inlet opening upwardly and exteriorly from the top wall member for delivery of carrier gas into the interior volume of the vessel, the carrier gas feed line containing a carrier gas flow control valve therein for control of flow of the carrier gas therethrough;

a non-centrally located portion of the top wall member having a vapor phase reagent outlet opening; and

a vapor phase reagent discharge line extending from the vapor phase reagent outlet opening upwardly and exteriorly from the top wall member for removal of vapor phase reagent from the interior volume of the vessel, the vapor phase reagent discharge line containing a vapor phase reagent flow control valve therein for control of flow of the vapor phase reagent therethrough.

This invention further relates to a vapor phase reagent dispensing apparatus or assembly described above further comprising:
a deposition chamber selected from a chemical vapor deposition chamber and an atomic layer deposition chamber;
the vapor phase reagent discharge line connecting the apparatus to the deposition chamber;
a heatable susceptor contained within the deposition chamber and located in a receiving relationship to the vapor phase reagent discharge line; and
an effluent discharge line connected to the deposition chamber;
   such that vapor phase reagent passes through the vapor phase reagent discharge line and into the deposition chamber, for contact with a substrate on the heatable susceptor and any remaining effluent is discharged through the effluent discharge line.

This invention yet further relates to a method for delivery of a vapor phase reagent to a deposition chamber comprising:

(a) providing a vapor phase reagent dispensing apparatus or assembly as described above;

(b) adding a reagent which is a liquid or solid at ambient temperature to said vapor phase reagent dispensing apparatus;

(c) heating the reagent in said vapor phase reagent dispensing apparatus to a temperature sufficient to vaporize the reagent to provide vapor phase reagent;

(d) feeding a carrier gas into said vapor phase reagent dispensing apparatus;

(e) withdrawing the vapor phase reagent and carrier gas from said vapor phase reagent dispensing apparatus through said vapor phase reagent discharge line; and

(f) feeding the vapor phase reagent and carrier gas into said deposition chamber.

The vapor phase reagent dispensing apparatus or assembly of the invention may be employed in a wide variety of process systems, including for example chemical vapor deposition systems wherein the vapor phase reagent from the supply vessel is passed to a chemical vapor deposition chamber for deposition of a material layer on a substrate therein from the source vapor.

This invention also relates to a method for delivery of a vapor phase reagent to a deposition chamber described above comprising:

(g) contacting the vapor phase reagent with a substrate on a heatable susceptor within the deposition chamber; and

(h) discharging any remaining effluent through an effluent discharge line connected to the deposition chamber.

This invention allows for a minimal amount of semiconductor precursor chemical to remain in the ampoule or bubbler when the liquid reagent level sensor has signaled the end of the contents. This is very important as the complexity and cost of semiconductor precursors rises. In order to minimize costs, semiconductor manufacturers will want to waste as little precursor as possible. In addition, this invention places the temperature sensor in the same recessed sump cavity as the liquid reagent level sensor. This ensures that the true temperature of the liquid semiconductor precursor will be read as long as the liquid reagent level sensor indicates there is precursor present. This is important from a safety standpoint. If the temperature sensor was to be outside of the liquid semiconductor precursor it would send a false low temperature signal to the heating apparatus. This could lead to the application of excessive heat to the ampoule which can cause an unsafe situation and decomposition of the semiconductor precursor.

This invention allows the semiconductor manufacturer to use the maximum amount of precursor while wasting very little before change-out of the ampoule. This minimizes waste and maximizes the return on the investment in the semiconductor precursor.

Other aspects, features and embodiments of the invention will be more fully apparent from the ensuing disclosure and appended claims.

### BRIEF DESCRIPTION OF THE DRAWINGS

FIG. 1 is a schematic representation of a vapor phase reagent dispensing apparatus shown in partial cross-section.

FIG. 2 is a top plan view of the bottom wall member surface of the vessel showing different configurations of the sump cavity. In FIG. 2A and FIG. 2B, two or more intersecting circular depressions or wells can serve as a sump cavity. In FIG. 2C, two or more circular depressions or wells joined by a connecting trench can serve as a sump cavity.

### DETAILED DESCRIPTION OF THE INVENTION

The vessel or ampoule is typically machined from 316L stainless steel and electropolished to prevent contamination of the precursor chemical. The cover is removable to facilitate cleaning and reuse. The temperature sensor is in the center of the ampoule to ensure uniform heat conduction. The valves and level sensor are attached via face seal connections to ensure a clean, leak proof seal. Once assembled in a clean room, the ampoule is conditioned to remove adsorbed water and leak checked with a helium leak detector. The ampoule is designed to be used at pressures from a few torr to slightly above ambient.

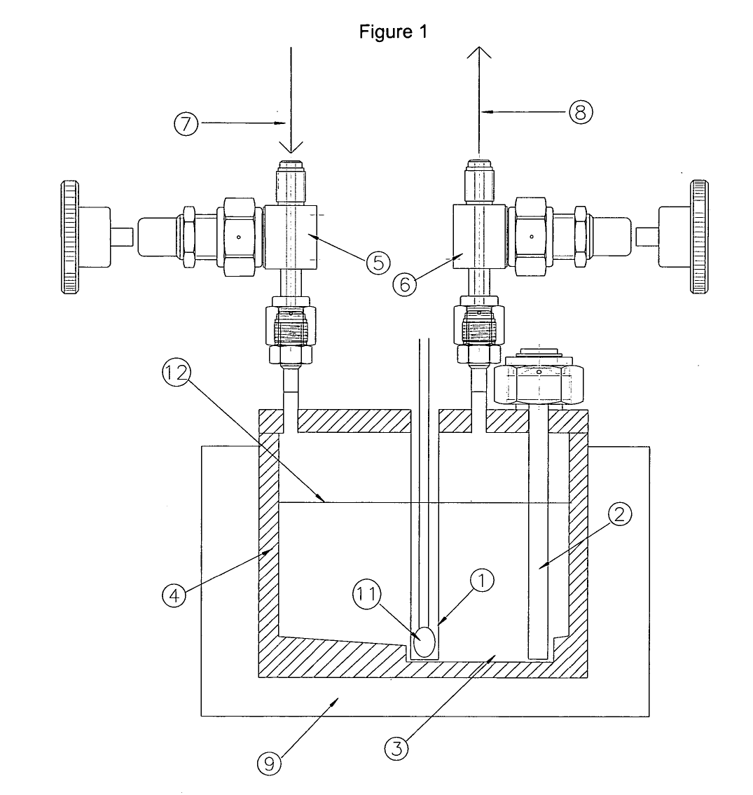

Referring to FIG. 1, the trench (3) machined into the bottom of the stainless steel ampoule (4) provides the sump cavity that minimizes the amount of material necessary for the liquid reagent level sensor (2) to detect. The trench also locates the liquid reagent level sensor and the temperature sensor (1) in the same sump cavity so that both detectors are always wet. In FIG. 1, the floor of the ampoule has a slope of 3 degrees toward a central point so that any remaining material is funneled into the trench, further minimizing chemical waste.

In one embodiment, the sump cavity is configured as a dual well structure in the floor member of the vessel, with one well containing the lower extremity of the temperature sensor and the other well containing the lower end of the liquid reagent level sensor element.

The sump cavity may suitably occupy a minor fraction, e.g., 20% or less, of the cross-section floor surface area of the vessel, and be readily constructed by machining, milling, boring or routing of the floor member of the vessel.

The thermowell depicted in FIG. 1 may be made from 0.375 inch tubing in order to accommodate a wide variety of thermocouples. A small amount of heat conducting oil will be placed in the thermowell to insure proper transmission of heat to the thermocouple. For the types of temperatures generally used in chemical vapor deposition, a K-type thermocouple is the most commonly used.

The dimensions of the trench should be deep enough to allow the liquid reagent level sensor to detect the fluid plus a small amount to allow clearance between the liquid reagent level sensor and the bottom of the trench. There should also be clearance around the temperature and liquid reagent level sensors themselves so that the sides of the trench do not interfere with the sensors. Approximately 0.125 inches of clearance is sufficient for most sensors. The temperature sensor should not contact the bottom or sides of the sump cavity and should be in non-interfering proximity therewith. The lower end of the temperature sensor should be located at the same or closer proximity to the sub-floor surface of the sump cavity in relation to the lower end of the liquid reagent level sensor.

In FIG. 1, the liquid reagent level sensor is an ultrasonic type sensor. This sensor has a dead space of only 0.3 inches. The ultrasonic sensor also has a diameter of only 0.5 inches so that the diameter of the trench is minimized. Using these numbers and assuming a one liter ampoule, the ampoule can be configured such that the level sensor will signal the end of material when only 1% is remaining. Illustrative liquid reagent level sensors useful in this invention include, for example, ultrasonic sensors, optical sensors, capacitive sensors and float-type sensors.

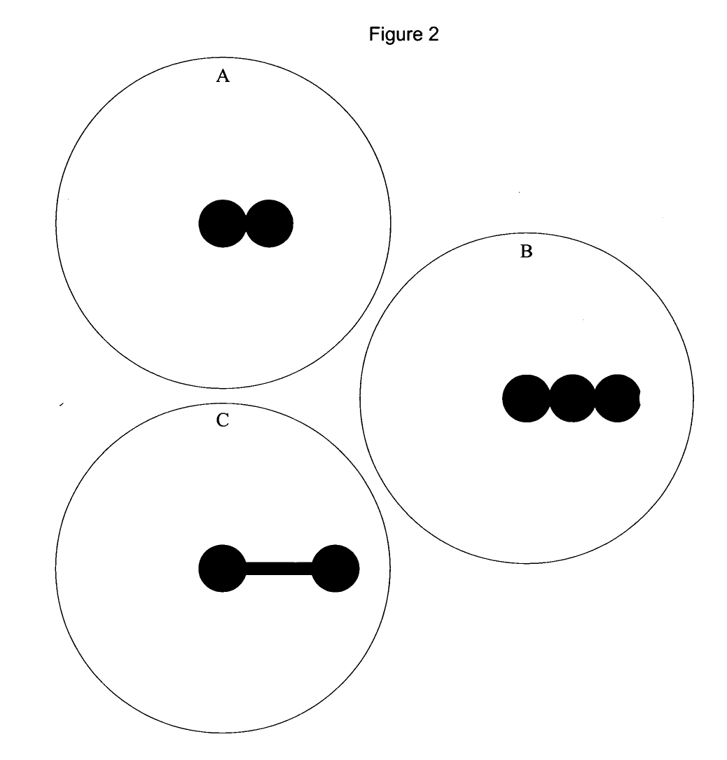

Although a trench has been specified, in this case due to ease of machining, alternate geometries of the sump could be employed. As shown in FIG. 2A and FIG. 2B, two, three or more intersecting circular depressions or wells could serve as a sump cavity. Alternately, two, three or more circular depressions or wells joined by a connecting trench can serve as a sump cavity as shown in FIG. 2C. These configurations would allow for minimal cross sectional area and thus the least wasted material.

In preferred embodiments, the sump cavity of the vapor phase reagent dispensing apparatus of this invention may have a dumbbell shape in top plan view of the bottom wall member surface. The sump cavity may also comprise two or three transversely spaced-apart circular depressions or wells in liquid flow communication with one another, with one of the circular depressions or wells having the lower end of the temperature sensor disposed therein and another of the circular depressions or wells having the lower end of the liquid reagent level sensor disposed therein. Further, the liquid reagent level sensor well may be connected to a temperature sensor well by a yoke passage, thereby defining a dumbbell conformation of the sump cavity.

The method to deliver 90% to 99% of a chemical that is a solid or liquid at room temperature comprises heating the chemical in the vessel to a temperature above its melting point and preferably to a temperature appropriate for its use in a chemical vapor deposition or atomic layer deposition process, by providing heat from the side walls as well as the bottom of the vessel or container, continuously monitoring both the temperature and the liquid level in a sump cavity at the bottom of the container, adjusting the heat input to control the liquid reagent temperature below the lower of normal boiling point, boiling point at the container pressure, and decomposition temperature of the liquid reagent, passing an inert gas into the container to mix with the vapor above the gas-liquid interface, and withdrawing the mixture of gas and vapor for delivery to a chemical vapor deposition or atomic layer deposition process.

The ampoule is installed on the chemical vapor deposition or atomic layer deposition tool by connecting to the two valves (5 and 6). The two valves (5 and 6) are isolation valves used during transport. Once installed on the tool, the valves are opened, the thermocouple (11) placed in the thermowell (1) and enough thermal conducting fluid is added to the thermowell to cover the thermocouple. The ampoule is placed inside of a heating mantle, block or bath (9) and brought up to delivery temperature. The temperature of the semiconductor precursor is monitored. through the use of the thermocouple in the thermowell. A carrier gas is introduced through the input (7) and passes through the headspace above the liquid-gas interface (12) which saturates it with the semiconductor precursor. The precursor saturated gas exits the ampoule through the outlet port (8) and is carried into the deposition tool. When the level of the liquid goes below the ultrasonic transducer in the level sensor (2) it causes an alert signal to be sent. The signal can be audio, visual, logical or combinations thereof. The logic signal enables the liquid reagent level sensor to communicate directly with the deposition tool.

During the deposition process, it is generally necessary to heat the vessel or ampoule by some means in order to increase the vapor pressure of the precursor and thus increase the amount of chemical in the carrier gas. It is important to monitor the temperature of the liquid precursor chemical inside of the ampoule to control the vapor pressure. This monitoring of the temperature of the semiconductor precursor can be accomplished by means of a thermocouple in the thermowell. As the semiconductor precursor is consumed, it will take less heat input to keep it at the target temperature. The heat source for the ampoule will need to be monitored by the thermocouple and the temperature of the heating block, mantle or bath adjusted accordingly.

It is necessary for the thermowell to be at a distance from the floor of the sump cavity such that it is still immersed in the liquid semiconductor precursor when the level sensor indicates the end of the chemical. The temperature sensor should not contact the bottom or sides of the sump cavity and should be in non-interfering proximity therewith. One way to ensure this is to make the level sensor and the thermowell project the same distance down from the ampoule cover or top wall member. The lower end of the temperature sensor should be located at the same or closer proximity to the sub-floor surface of the sump cavity in relation to the lower end of the liquid reagent level sensor. This configuration takes advantage of the dead space on the level sensing device to ensure that the thermowell is always wet. This is important not only as a safety consideration, but it also ensures that the precursor temperature does not exceed the decomposition temperature.

The system described is for a vessel or ampoule with both a liquid reagent level sensor and a temperature sensor. It may be possible to combine a level sensor and a thermocouple into one probe. In that case, a singular circular depression would be the only sump needed. It is also possible that an ampoule would not need to be heated, thus obviating the need for a temperature sensor. In such a case, a singular circular depression would be the only sump cavity needed.

A solid insert could be devised to create a sump cavity in order to modify an existing ampoule. The insert would have to be permanently attached to the ampoule by welding or some other method in order to prevent movement of the insert during shipping and ensure that the trench lined up with the level sensor and temperature sensor.

The system illustrated in FIG. 1 is for use with an ultrasonic level sensor. An optical level sensor could be used but may require a deeper well. A magnetic float type of sensor could also be used but may require a larger diameter sump cavity to accommodate the diameter of the magnetic float.

While only an end point liquid reagent level sensor with only one detection point has been discussed, it is possible to use a multipoint or continuous liquid reagent level sensor and monitor the consumption of semiconductor precursor as it is being used. It is necessary to ensure that the last point of detection is inside of the well to get the benefit of the invention.

The system illustrated in FIG. 1 is for use with a thermowell (1) and thermocouple (11). It will be appreciated that other types of temperature sensing devices may be used in the practice of this invention and may be widely varied in practice.

The system depicted in FIG. 1 is for an ampoule with both a liquid reagent level sensor and a temperature sensor. As a result of this, the trench has been designed to handle two tubular probes. This system could also be used with a tube attached to the carrier gas feed inlet opening, thus turning the ampoule into a bubbler. It may be desirable to have the inlet tube extend down into the sump cavity as well so as to maximize the path length of the bubble. This will maximize the amount of dissolved chemical in the bubbler and make the bubbler more efficient. If a bubbler tube is added, a third cavity may need to be added to the sump cavity or the trench may need to be extended.

The vessel or ampoule includes side wall member(s) which may, for example, comprise a cylindrical wall or wall segments corporately defining an enclosing side wall structure, e.g., of square or other non-cylindrical cross-section, a top wall member and a bottom wall member or floor member. The side wall, top wall and bottom wall or floor members define an enclosed interior volume of the vessel, which in operation may contain a gas space overlying a liquid defining a liquid surface at the gas-liquid interface (12).

The top wall member or cover of the ampoule may be removable or fixed. Preferably, the cover is removable to facilitate cleaning and inspection of the ampoule. A deformable metal O-ring can form a vacuum tight seal between the top wall member and the side wall member(s) of the ampoule. The metal O-ring can be made of stainless steel, nickel or any metal that can be deformed. The metal seals can prevent diffusion of air or water which can occur with polymer seals.

In accordance with the invention, the floor member has a main floor surface and is provided with a sump cavity therein. The sump cavity extends downwardly from the main floor surface into a subfloor surface with a bounding side wall surface of the cavity.

The vessel (4) is equipped with carrier gas introduction means which comprises a carrier gas input (7) having a carrier gas flow control valve (5) coupled therewith to control the flow of carrier gas into the interior volume of the vessel. The carrier gas feed inlet (7) is joined by coupling to a supply line from a carrier gas supply unit (not shown in the drawings), so that the carrier gas from the supply unit flows through the supply line to the carrier gas feed inlet (7) and is discharged in the interior of the vessel. The carrier gas supply unit may be of any suitable type, as for example a high pressure gas cylinder, a cryogenic air separation plant, or a pressure swing air separation unit, furnishing a carrier gas, e.g., nitrogen, argon, helium, etc., to the supply line.

Vapor phase reagent discharge line (8) receives the vapor phase reagent which is discharged from the interior volume of the vessel, and flows same to a chemical vapor deposition chamber (not shown in the drawings). In the chemical vapor deposition chamber, a wafer, e.g., patterned wafer, or other substrate element is mounted on a heatable susceptor or other mount structure, in receiving relationship to the source vapor introduced to the chamber from the vapor phase reagent discharge line (8).

The vapor is contacted with the wafer to deposit thereon the desired component(s) of the source vapor, and form a resulting material layer or deposit on the wafer. The effluent gas from the chemical vapor deposition is discharged from chamber in an effluent discharge line, and may be passed to recycle, recovery, waste treatment, disposal, or other disposition means (not shown in the drawings).

Referring again to the vessel or ampoule, the vessel is equipped with a liquid reagent level sensor (2) which extends from an upper portion exterior of the vessel, downwardly through a non-centrally located portion of the top wall member of the vessel, to a lower end, non-centrally located on the bottom floor member, in close proximity to the sub-floor surface of the sump cavity (3) of the vessel to permit utilization of at least 95% of liquid reagent when liquid reagent is contained in the vessel. The upper portion of the liquid reagent level sensor (2) may be connected by a liquid reagent level sensing signal transmission line to a central processing unit, for transmission of sensed liquid reagent level signals from the liquid reagent level sensor to the central processing unit during operation of the system.

In a like manner, the vessel is equipped with a temperature sensor, i.e., a thermowell (1) and thermocouple (11), which extends from an upper portion exterior of the vessel, downwardly through a centrally located portion of the top wall member of the vessel, to a lower end, centrally located on the bottom wall member, in close proximity to the sub-floor surface of the sump cavity (3) of the vessel. The upper portion of the temperature sensor (11) may be connected by a temperature sensing signal transmission line to a central processing unit, for transmission of sensed temperature signals from the temperature sensor to the central processing unit during operation of the system.

The central processing unit, which may comprise a suitable microprocessor, computer, or other appropriate control means, may also be joined by a control signal transmission line to flow control valve (5) (e.g., via a suitable valve actuator element not shown in the drawings) to selectively adjust flow control valve (5) and control the flow of carrier gas to the vessel. The central processing unit may also be joined by a control signal transmission line to flow control valve (6) (e.g., via a suitable valve actuator element not shown in the drawings) to selectively adjust flow control valve (6) and control the discharge of vapor phase reagent from the vessel. For purposes of this invention, flow control valves shall include isolation valves, metering valves and the like.

The sump cavity may preferably occupy a minor portion of the cross-sectional floor area of the vessel. In general, a plan view cross-sectional area of the sump cavity is preferably less than about 25% of the total cross-sectional area of the vessel floor, and more preferably less than about 15% of the total cross-sectional area of the vessel floor. For example, the cross-sectional area of the sump cavity may be in the range of from about 5 to about 20% of the total cross-sectional area of the vessel (floor area). The side-walls of the sump cavity may be sloped, straight or of any other geometry or orientation.

It will be appreciated that the conformation, including the shape, geometry and dimensions, of the sump cavity in the practice of this invention may be widely varied in practice.

For example, the sump cavity may comprise separate discrete interconnected wells for the respective temperature sensor and liquid reagent level sensor lower end portions. These wells should be communicated with one another by a passage extending through the floor member of the supply vessel and communicating at respective ends with the wells in the vicinity of the sub-floor surfaces of the wells. Such interconnecting passage may for example be a generally horizontally extending passage, or it may for example comprise a U-shape or manometric-type passage between the respective wells of the floor member of the vessel, or it may have any other suitable shape and configuration for the purpose of communicating the wells or constituent parts of the sump cavity.

The sump cavity may be formed in the floor member of the liquid reagent supply vessel by any suitable manufacturing method, including casting, molding, etching, machining (drilling, milling, electric arc machining, etc.), or any other method providing a cavity structure in the floor member which provides a liquid holding volume of reduced cross-sectional area in the lower portion of the interior volume of the vessel or ampoule, so that a given volume of liquid occupies a greater height than would be the case in an interior volume of uniform cross-sectional area over its entire vertical extent.

In an illustrative operation of the system, liquid reagent is placed in the vessel (4), heated and a carrier gas is flowed from a carrier gas supply unit through a carrier gas supply line to the gas feed inlet (7) from which it is discharged into the interior volume of the vessel. It is necessary to heat the vessel by some means in order to increase the vapor pressure of the precursor and thus increase the amount of chemical in the carrier gas. The resulting vapor and carrier gas are discharged from the vessel through the vapor phase reagent discharge line and flowed to the chemical vapor deposition chamber for deposition of the desired material layer or deposit on the substrate. Effluent vapor and carrier gas are discharged from the chamber in an effluent discharge line.

During this operation, the liquid reagent level of the liquid in vessel (4) is detected by a liquid reagent level sensor (2). It is important to know when the liquid precursor chemical inside of the vessel is close to running out so that it can be changed at the end of a chemical vapor deposition or atomic layer deposition cycle. The liquid reagent level progressively declines and eventually lowers into the sump cavity (3) to a minimum liquid head (height of liquid in the sump cavity), at which point the central processing unit receives a corresponding sensed liquid level signal by a liquid level sensing signal transmission line. The central processing unit responsively transmits a control signal in a control signal transmission line to the carrier gas flow control valve (5) to close the valve and shut off the flow of carrier gas to the vessel, and also concurrently transmits a control signal in a control signal transmission line to close the vapor phase reagent flow control valve (6), to shut off the flow of vapor phase reagent from the vessel.

Also, during this operation, the temperature of the liquid in vessel (4) is detected by a temperature sensor (11). It is important to monitor the temperature of the liquid precursor chemical inside of the vessel to control the vapor pressure. If the temperature of the liquid reagent in the vessel becomes too high, the central processing unit receives a corresponding sensed temperature signal by a temperature sensing signal transmission line. The central processing unit responsively transmits a control signal in a control signal transmission line to heating block (9) to decrease the temperature.

By acting at the end of the vapor phase reagent dispensing operation on a reduced cross-section, the increased height liquid volume in the sump cavity in accordance with this invention, the liquid reagent level sensor and temperature sensor are able to monitor the liquid reagent level and temperature to a closer approach to complete liquid utilization.

The means and method of this invention thus achieves a substantial advance in the art, in the provision of a system for supply and dispensing of a vapor phase reagent, which permits 95-98% of the volume of the originally furnished liquid reagent to be utilized in the application for which the vapor phase reagent is selectively dispensed.

Correspondingly, in operations such as the manufacture of semiconductor and superconductor products, it is possible with the means and method of this invention to reduce the waste of the liquid reagent to levels as low as 2-5% of the volume originally loaded into the dispensing vessel.

Accordingly, the practice of this invention markedly improves the economics of the liquid reagent supply and vapor phase reagent dispensing system, and the process in which the dispensed vapor phase reagent is employed. The invention in some instances may permit the cost-effective utilization of liquid reagents which were as a practical matter precluded by the waste levels characteristic of prior art practice.

As a further benefit of this invention, the reduced liquid reagent inventory in the vessel at the end of the vapor phase reagent dispensing operation permits the switch-over time, during which the exhausted supply vessel is changed out from the process system, and replaced with another vessel for further processing, to be minimized as a result of the greater on-stream time for the supply vessel owing to increased usage of the originally charged liquid therefrom, relative to such prior practice.

The liquid reagent precursors useful in this invention are preferably organometallic compound precursors. The organometallic precursors may be comprised of expensive metals, for example, ruthenium, hafnium, tantalum, molybdenum, platinum, gold, titanium, lead, palladium, zirconium, bismuth, strontium, barium, calcium, antimony and thallium, or metalloids such as silicon or germanium. Preferred organometallic precursor compounds include ruthenium-containing, hafnium-containing, tantalum-containing and/or molybdenum-containing organometallic precursor compounds.

In an embodiment of this invention, an organometallic compound is employed in vapor phase deposition techniques for forming powders, films or coatings. The compound can be employed as a single source precursor or can be used together with one or more other precursors, for instance, with vapor generated by heating at least one other organometallic compound or metal complex.

Deposition can be conducted in the presence of other vapor phase components. In an embodiment of the invention, film deposition is conducted in the presence of at least one non-reactive carrier gas. Examples of non-reactive gases include inert gases, e.g., nitrogen, argon, helium, as well as other gases that do not react with the organometallic compound precursor under process conditions. In other embodiments, film deposition is conducted in the presence of at least one reactive gas. Some of the reactive gases that can be employed include but are not limited to hydrazine, oxygen, hydrogen, air, oxygen-enriched air, ozone (O₃), nitrous oxide (N₂O), water vapor, organic vapors, ammonia and others. As known in the art, the presence of an oxidizing gas, such as, for example, air, oxygen, oxygen-enriched air, O₃, N₂O or a vapor of an oxidizing organic compound, favors the formation of a metal oxide film.

Deposition methods described herein can be conducted to form a film, powder or coating that includes a single metal or a film, powder or coating that includes a single metal oxide. Mixed films, powders or coatings also can be deposited, for instance mixed metal oxide films. A mixed metal oxide film can be formed, for example, by employing several organometallic precursors, at least one of which being selected from the organometallic compounds described above.

Vapor phase film deposition can be conducted to form film layers of a desired thickness, for example, in the range of from less than 1 nm to over 1 mm. The precursors described herein are particularly useful for producing thin films, e.g., films having a thickness in the range of from about 10 nm to about 100 nm. Films of this invention, for instance, can be considered for fabricating metal electrodes, in particular as n-channel metal electrodes in logic, as capacitor electrodes for DRAM applications, and as dielectric materials.

The deposition method also is suited for preparing layered films, wherein at least two of the layers differ in phase or composition. Examples of layered film include metal-insulator-semiconductor, and metal-insulator-metal.

The organometallic compound precursors can be employed in chemical vapor deposition or, more specifically, in metalorganic chemical vapor deposition processes known in the art. For instance, the organometallic compound precursors described above can be used in atmospheric, as well as in low pressure, chemical vapor deposition processes. The compounds can be employed in hot wall chemical vapor deposition, a method in which the entire reaction chamber is heated, as well as in cold or warm wall type chemical vapor deposition, a technique in which only the substrate is being heated.

The organometallic compound precursors described above also can be used in plasma or photo-assisted chemical vapor deposition processes, in which the energy from a plasma or electromagnetic energy, respectively, is used to activate the chemical vapor deposition precursor. The compounds also can be employed in ion-beam, electron-beam assisted chemical vapor deposition processes in which, respectively, an ion beam or electron beam is directed to the substrate to supply energy for decomposing a chemical vapor deposition precursor. Laser-assisted chemical vapor deposition processes, in which laser light is directed to the substrate to affect photolytic reactions of the chemical vapor deposition precursor, also can be used.

The deposition method can be conducted in various chemical vapor deposition reactors, such as, for instance, hot or cold-wall reactors, plasma-assisted, beam-assisted or laser-assisted reactors, as known in the art.

Examples of substrates that can be coated employing the deposition method include solid substrates such as metal substrates, e.g., Al, Ni, Ti, Co, Pt, Ta; metal silicides, e.g., TiSi₂, CoSi₂, NiSi₂; semiconductor materials, e.g., Si, SiGe, GaAs, InP, diamond, GaN, SiC; insulators, e.g., SiO₂, Si₃N₄, HfO₂, Ta₂O₅, Al₂O₃, barium strontium titanate (BST); barrier materials, e.g., TiN, TaN; or on substrates that include combinations of materials. In addition, films or coatings can be formed on glass, ceramics, plastics, thermoset polymeric materials, and on other coatings or film layers. In a preferred embodiment, film deposition is on a substrate used in the manufacture or processing of electronic components. In other embodiments, a substrate is employed to support a low resistivity conductor deposit that is stable in the presence of an oxidizer at high temperature or an optically transmitting film.

The deposition method can be conducted to deposit a film on a substrate that has a smooth, flat surface. In an embodiment, the method is conducted to deposit a film on a substrate used in wafer manufacturing or processing. For instance, the method can be conducted to deposit a film on patterned substrates that include features such as trenches, holes or vias. Furthermore, the deposition method also can be integrated with other steps in wafer manufacturing or processing, e.g., masking, etching and others.

Chemical vapor deposition films can be deposited to a desired thickness. For example, films formed can be less than 1 micron thick, preferably less than 500 nanometers and more preferably less than 200 nanometers thick. Films that are less than 50 nanometers thick, for instance, films that have a thickness between about 0.1 and about 20 nanometers, also can be produced.

Organometallic compound precursors described above also can be employed in the method of the invention to form films by atomic layer deposition or atomic layer nucleation techniques, during which a substrate is exposed to alternate pulses of precursor, oxidizer and inert gas streams. Sequential layer deposition techniques are described, for example, in U.S. Pat. No. 6,287,965 and in U.S. Pat. No. 6,342,277. The disclosures of both patents are incorporated herein by reference in their entirety.

For example, in one atomic layer deposition cycle, a substrate is exposed, in step-wise manner, to: a) an inert gas; b) inert gas carrying precursor vapor; c) inert gas; and d) oxidizer, alone or together with inert gas. In general, each step can be as short as the equipment will permit (e.g. milliseconds) and as long as the process requires (e.g. several seconds or minutes). The duration of one cycle can be as short as milliseconds and as long as minutes. The cycle is repeated over a period that can range from a few minutes to hours. Film produced can be a few nanometers thin or thicker, e.g., 1 millimeter (mm).

Various modifications and variations of this invention will be obvious to a worker skilled in the art and it is to be understood that such modifications and variations are to be included within the purview of this application and the spirit and scope of the claims.

### EXAMPLE 1

### Chemical Vapor Deposition Using Tetrakis Dimethyl Amino Hafnium (TDMAH)

An ampoule as depicted in FIG. 1 is filled approximately ¾ full with TDMAH. TDMAH is a solid at ambient temperature and melts at approximately 29° C. The liquid reagent level sensor is a single point optical type that works by internal reflection of a light source when the sensor is in contact with a liquid. When no liquid is present, there is no internal reflection. The liquid reagent level sensor sends a signal when the TDMAH precursor content of the ampoule passes the end of the sensor.

The level sensor is mounted thru a ¾ inch face seal connection. The temperature sensor is a K type thermocouple in an all welded thermowell located in the center of the ampoule cover. The thermowell is filled with a high temperature, heat conducting oil to ensure contact between the temperature sensor and the thermowell. The ends of the thermowell and level sensor extend into the sump cavity on the floor of the ampoule. The seal between the ampoule cover and the body of the ampoule is a deformable stainless steel O-ring. The carrier gas is nitrogen. The pressure of the gas is from 1 mTorr to 1000 Torr.

A suitable delivery temperature for TDMAH is between 40° C. and 100° C. Once the temperature sensor indicates that the ampoule has reached delivery temperature, the valves are opened allowing the carrier gas to enter the ampoule and a TDMAH precursor/carrier gas mixture to exit the ampoule. The TDMAH precursor/carrier gas mixture travels through tubing, is heated to between 10 to 20 degrees hotter than the ampoule to prevent condensation of the TDMAH precursor within the connecting lines, to the chemical vapor deposition chamber. Inside the chemical vapor deposition chamber is a 300 mm silicon wafer that has been previously modified (e.g., patterned, etched, doped, etc.). The wafer is heated to between 200° C. and 700° C. Inside the chemical vapor deposition chamber, the precursor mixture comes into contact with oxygen at the surface of the wafer and hafnium oxide begins to grow. The wafer is exposed for a time between a few seconds and a few minutes to allow for growth of the oxide film to the desired thickness before gas flow is terminated.

### EXAMPLE 2

### Atomic Layer Deposition Using Tetrakis Diethyl Amino Hafnium (TDEAH)

An ampoule as depicted in FIG. 1 is filled approximately ¾ full with TDEAH. TDEAH is a liquid at ambient temperature. The liquid reagent level sensor is a four point ultrasonic type that works by comparing the sonic conductance of a liquid to a gas. The liquid reagent level sensor sends a different signal when the TDEAH precursor content of the ampoule reaches any of four preset points with the last point being the end of the sensor. In this way the consumption rate of TDEAH precursor within the ampoule is monitored during use thereof. This monitoring allows for better planning of ampoule change out and gives the semiconductor manufacturer additional data about the process.

The level sensor is mounted thru a ¾ inch face seal connection. The temperature sensor is a K type thermocouple in an all welded thermowell located in the center of the ampoule cover. The thermowell is filled with a high temperature, heat conducting oil to ensure contact between the temperature sensor and the thermowell. The ends of the thermowell and level sensor extend into the sump cavity on the floor of the ampoule. The seal between the ampoule cover and the body of the ampoule is a deformable nickel O-ring. The carrier gas is nitrogen. The pressure of the gas is from 1 mTorr to 1000 Torr.

A suitable delivery temperature for TDEAH is between 80° C. and 120° C. Once the temperature sensor indicates that the ampoule has reached the appropriate delivery temperature, the valves are opened allowing the carrier gas to enter the ampoule and a TDEAH precursor/carrier gas mixture to exit the ampoule. At this point, another valve controls the delivery of the TDEAH precursor/carrier gas mixture to an atomic layer deposition chamber. The valve and the connecting tubing are heated to between 10 to 20 degrees hotter than the ampoule to prevent condensation of TDEAH precursor within the connecting lines, to the atomic layer deposition chamber. Inside the atomic layer deposition chamber is a 300 mm silicon wafer heated to between 200° C. and 700° C. that has been previously modified (e.g. patterned, etched, doped, etc.). The precursor deposits on the surface of the wafer in the atomic layer deposition chamber. Once sufficient time has passed for a complete monolayer to form on the surface of the wafer, usually a few seconds, the flow of TDEAH precursor/carrier gas mixture is interrupted and the chamber is purged with nitrogen. Oxygen is then introduced to the atomic layer deposition chamber and allowed to react with the TDEAH precursor on the surface of the wafer forming an oxide. Once the reaction is complete, nitrogen is used to purge the chamber and the process is repeated with a new charge of TDEAH precursor/carrier gas. The process is repeated depending on how many layers of oxide are needed. Typical repetitions are from tens of cycles to hundreds of cycles.

1. A vapor phase reagent dispensing apparatus comprising:
a vessel bounded on its upper end by a top wall member and on its lower end by a bottom wall member to define therewithin an interior volume;
the bottom wall member having a main floor surface containing a sump cavity therein extending downwardly from the main floor surface, the sump cavity being bounded at its lower end by a sub-floor surface, with at least a portion of the sump cavity being centrally located on the bottom wall member and at least a portion of the sump cavity being non-centrally located on the bottom wall member;
a temperature sensor extending from an upper end exterior of the vessel through a centrally located portion of the top wall member and generally vertically downwardly into the interior volume of the vessel to a lower end of that portion of the sump cavity centrally located on the bottom wall member, with the lower end of the temperature sensor being located in non-interfering proximity to the sub-floor surface of the sump cavity;
a liquid reagent level sensor extending from an upper end exterior of the vessel through a non-centrally located portion of the top wall member and generally vertically downwardly into the interior volume of the vessel to a lower end of that portion of the sump cavity non-centrally located on the bottom wall member, with the lower end of the liquid reagent level sensor being located in non-interfering proximity to the sub-floor surface of the sump cavity; and
the temperature sensor being operatively arranged in the sump cavity to determine the temperature of liquid reagent in the vessel, the liquid reagent level sensor being operatively arranged in the sump cavity to determine the level of liquid reagent in the vessel, the temperature sensor and liquid reagent level sensor being located in non-interfering proximity to each other in the sump cavity, with the lower end of the temperature sensor being located at the same or closer proximity to the sub-floor surface of the sump cavity in relation to the lower end of the liquid reagent level sensor, and the temperature sensor and liquid reagent level sensor being in liquid reagent flow communication in the sump cavity.

2. The vapor phase reagent dispensing apparatus of claim 1 further comprising:
a non-centrally located portion of the top wall member having a carrier gas feed inlet opening;
a carrier gas feed line extending from the carrier gas feed inlet opening upwardly and exteriorly from the top wall member for delivery of carrier gas into the interior volume of the vessel, the carrier gas feed line containing a carrier gas flow control valve therein for control of flow of the carrier gas therethrough;
a non-centrally located portion of the top wall member having a vapor phase reagent outlet opening; and
a vapor phase reagent discharge line extending from the vapor phase reagent outlet opening upwardly and exteriorly from the top wall member for removal of vapor phase reagent from the interior volume of the vessel, the vapor phase reagent discharge line containing a vapor phase reagent flow control valve therein for control of flow of the vapor phase reagent therethrough.

3. The vapor phase reagent dispensing apparatus of claim 2 further comprising the vapor phase reagent discharge line in vapor phase reagent flow communication with a vapor phase delivery deposition system, said deposition system selected from a chemical vapor deposition system and an atomic layer deposition system.

4. The vapor phase reagent dispensing apparatus of claim 1 wherein the sump cavity comprises a minor fraction of the area of the bottom wall member.

5. The vapor phase reagent dispensing apparatus of claim 1 wherein the sump cavity occupies less than 20% of the bottom wall member surface area.

6. The vapor phase reagent dispensing apparatus of claim 1 wherein the sump cavity has two or three intersecting circular depressions in top plan view of the bottom wall member surface.

7. The vapor phase reagent dispensing apparatus of claim 1 wherein the sump cavity comprises two or three transversely spaced-apart circular depressions in liquid flow communication with one another, with one of the circular depressions having the lower end of the temperature sensor disposed therein and another of the circular depressions having the lower end of the liquid reagent level sensor disposed therein.

8. The vapor phase reagent dispensing apparatus of claim 1 wherein the lower end of the liquid reagent level sensor is in sufficiently close proximity to the sub-floor surface of the sump cavity to permit utilization of at least 95% of liquid reagent when liquid reagent is contained in the vessel.

9. The vapor phase reagent dispensing apparatus of claim 1 wherein said liquid reagent level sensor is selected from the group consisting of ultrasonic sensors, optical sensors, capacitive sensors and float-type sensors, and said temperature sensor comprises a thermowell and thermocouple.

10. The vapor phase reagent dispensing apparatus of claim 1 wherein the vessel comprises a cylindrically shaped side wall member or side wall members defining a non-cylindrical shape.

11. The vapor phase reagent dispensing apparatus of claim 1 wherein the top wall member is removable.

12. The vapor phase reagent dispensing apparatus of claim 1 wherein the vapor phase reagent comprises a precursor for a metal selected from the group consisting of ruthenium, hafnium, tantalum, molybdenum, platinum, gold, titanium, lead, palladium, zirconium, bismuth, strontium, barium, calcium, antimony and thallium, or a precursor for a metalloid selected from the group consisting of silicon and germanium.

13. The vapor phase reagent dispensing apparatus of claim 1 wherein the sump cavity is defined at least in part by a sloping wall surface.

14. The vapor phase reagent dispensing apparatus of claim 2 further comprising a carrier gas source coupled to the carrier gas feed line.

15. The vapor phase reagent dispensing apparatus of claim 2 further comprising:
a deposition chamber selected from a chemical vapor deposition chamber and an atomic layer deposition chamber;
the vapor phase reagent discharge line connecting the apparatus to the deposition chamber;
a heatable susceptor contained within the deposition chamber and located in a receiving relationship to the vapor phase reagent discharge line; and
an effluent discharge line connected to the deposition chamber;
such that vapor phase reagent passes through the vapor phase reagent discharge line and into the deposition chamber, for contact with a substrate on the heatable susceptor and any remaining effluent is discharged through the effluent discharge line.

16. A method for delivery of a vapor phase reagent to a deposition chamber comprising:
(a) providing a vapor phase reagent dispensing apparatus in accordance with claim 2;
(b) adding a reagent which is a liquid or solid at ambient temperature to said vapor phase reagent dispensing apparatus;
(c) heating the reagent in said vapor phase reagent dispensing apparatus to a temperature sufficient to vaporize the reagent to provide vapor phase reagent;
(d) feeding a carrier gas into said vapor phase reagent dispensing apparatus;
(e) withdrawing the vapor phase reagent and carrier gas from said vapor phase reagent dispensing apparatus through said vapor phase reagent discharge line; and
(f) feeding the vapor phase reagent and carrier gas into said deposition chamber.

17. The method of claim 16 further comprising:
(g) contacting the vapor phase reagent with a substrate on a heatable susceptor within the deposition chamber; and
(h) discharging any remaining effluent through an effluent discharge line connected to the deposition chamber.

18. The method of claim 16 in which the deposition chamber is selected from a chemical vapor deposition chamber and an atomic layer deposition chamber

19. The method of claim 17 wherein said substrate is comprised of a material selected from the group consisting of a metal, a metal silicide, a semiconductor, an insulator and a barrier material.

20. The method of claim 17 wherein said substrate is a patterned wafer.
